(19) United States
(12) Patent Application Publication
(10) Pub. No.: US 2012/0084369 A1
(43) Pub. Date: Apr. 5, 2012

(54) Unified Reconnection To Multiple Remote Servers

(75) Inventors: Alberto Henriquez, Bothell, WA (US); Kevin London, Monroe, WA (US); Raymond M. Reskusich, Seattle, WA (US); Kashif Mehmood, Bellevue, WA (US); James Baker, Sammamish, WA (US); Debaprajna Bhattacharyya, Redmond, WA (US)

(73) Assignee: Microsoft Corporation, Redmond, WA (US)

(21) Appl. No.: 12/963,528

(22) Filed: Dec. 8, 2010

Related U.S. Application Data
(60) Provisional application No. 61/397,710, filed on Sep. 30, 2010.

(51) Int. Cl. G06F 15/16

(52) U.S. Cl. 709/206; 709/227

(57) ABSTRACT

Techniques are disclosed for connecting a user to all of his resources (e.g. remote desktop or remote application) in a deployment of server farm(s). The user's client sends a message to the deployment requesting any disconnected resources for the user and/or any active resources communicating with a different client. The deployment determines what those resources are, then strips out redundant information (e.g. two resources are remote applications executing within the same session) and sends a stripped list to the client, which reconnects. The client first reconnects to a resource that is not a VM and stores any user input (e.g. credentials) prompted for during that log in. Then, it reconnects to the other resources in parallel, using in these later reconnections any input received from the client during the first reconnection.

### CROSS-REFERENCE TO RELATED APPLICATIONS

This application claims benefit under 35 U.S.C. §119(e) of provisional U.S. patent application No. 61/397,710 filed on Sep. 30, 2010, the contents of which is incorporated by reference herein in its entirety.

### BACKGROUND

It has been common to share a computer desktop and applications with a remote client using remote presentation technologies, such as Remote Desktop Protocol (RDP), Remote Desktop Session Host (RDSH), Terminal Services, and Remote Desktop Services (RDS) Such shared computing systems typically are established through instantiating a user session for the remote presentation session on the server. Where the server's screen is to be shared with a client of the session, the remote presentation session obtains that information from a console session that is local to the server. During the remote presentation session, the client transmits the keyboard presses and mouse clicks or selections to the server, and the server sends screen updates back in the other direction to the client over a network connection (e.g., the INTERNET). As such, the user of the client has the experience as if his or her computer is executing the applications locally, when in reality the client computer is only sent screenshots of the applications as they appear on the server side.

In some remote presentation scenarios, an entire desktop is remoted to the client. For example, in a virtual desktop session a single user connects to an operating system executed within a virtual machine and the entire desktop is remoted to the client. In a remote desktop session, multiple users connect to a single operating system and the user interface is remoted to the client. In other remote presentation scenarios, a specific application is remoted to the client. This second scenario is sometimes referred to as “application remoting.” There are many advantages to remoting applications, such as ease of administration, clients can be cheaper because they are required to do less processing, and applications may be run close to their data source. Where a client is accessing multiple remote applications concurrently, it may be appropriate to refer to the remote resources that the client accesses, rather than the remote presentation sessions that the client is engaged in. This is because, where a single server farm serves two remote applications to the client, these remote applications may both execute within the same session on the server farm, so may be part of a single remote presentation session with the server farm. As used herein, “remote resource” may refer to a remote application, a remote desktop, a virtual desktop, or the like.

### SUMMARY

It would be an improvement to provide techniques for concurrently accessing multiple remote resources.

For example, when a user is concurrently accessing multiple remote resources from a first client computer, then moves to a different client computer, or gets disconnected and wants to reconnect with the first client computer, it may be difficult for the user to regain all of his or her remote resources. A user may need to know which servers he or she is connected to, or which applications he or she was using to be able to regain all of the remote resources that he or she was using. This is not an ideal situation and it makes it hard for users to work with many remote resources.

When a user connects to a particular server for a remote session, all of the running remote applications for that user on that server will be remoted to the user and he or she will be reconnected to the applications from the workspace on that server. This is true, for instance, in an embodiment where a user is given one session on the server in which to execute remoted apps, and the windows for those remoted apps is transmitted to the user (but not the desktop associated with the session). In this example, the connection is with the session, and all remoted applications are part of that session, so one reconnection to the session results in a reconnection to all of the remoted applications. This may not hold in other scenarios, such as where each remoted application is executed in a separate user session.

Where the remoted applications of a workspace are spread across multiple servers, reconnecting to a single remoted application will not result in reconnecting to all of the remoted applications.

A further problem is that, when reconnecting to multiple servers, the user may see multiple prompts for user names, for passwords, or many different error conditions. Seeing these multiple prompts may negatively impact the user experience because each prompt requires user interaction, and reduces the seamlessness of the user experience.

The present techniques render these problems moot by creating a scenario where users can automatically reconnect to all of the remote resources that he was using from any computer that he uses. In an embodiment, a user has a workspace on a first computer. A workspace is one or more remote resources received by a client computer and from a server computer, such as a Remote Desktop Web Connection (“RDWeb”) server. The remote resources may come from different remote presentation servers, or from a desktop virtualization host computer (such as a Remote Desktop Virtualization Host—RDVH—virtual machine) via remote programs (such as Remote Application Integrated Locally—RAIL—programs). A process on the client computer that manages the workspace maintains an identifier to connect to a web service using a Simple Object Access Protocol (SOAP). This identifier may be, for instance, a uniform resource locator (URL) for the location of the web service that is contained in an extensible markup language (XML) feed that is downloaded when the client computer subscribed to the workspace. The client may authenticate itself to the web service using a cookie that was sent from the server when the user subscribed to the feed. The web service uses the cookie to authenticate the user and get the user's identity. The web service uses a remote procedure call (RPC) to send the workspace and user identifier to a centralized publishing service. The centralized publishing service uses this information to query the session broker to get a list of sessions (disconnected and/or active sessions connected to a different machine) associated with that user ID and workspace. Then, the centralized publishing service matches remote presentation files associated with the individual machines that have a session and/or an active session connected to a different machine, and modifies each remote presentation file so that it indicates a reconnection. The centralized publishing service returns that list of modified remote presentation files to the web service, which returns this list to the workspace process on the client computer.

The user's computer having the remote presentation files, the reconnection process between the client computer and the remote servers begins. Each connection starts a new process (such as mstsc.exe in versions of the MICROSOFT WINDOWS operating system. mstsc.exe is configured to create remote presentation connections with other computers). While there may be multiple connections to be made, initially a single connection is made before the others are made. A single connection is first made because there may be a prompt condition common to all of the connections—such as a prompt for a user name and password. By connecting only a single connection at first, there may be only one such prompt, and then this information may be used for all of the other connections. After the single connection is made, the other connections can be made in parallel.

When reconnecting to a remote application, the process on the client that establishes the reconnection drops a packet (or otherwise does not send a packet that it would send in the course of a connection request, as opposed to this reconnection request) that causes a new application to be started, and this reconnects the user to the remote resources on that server without starting a new application (an instance of this process may be instantiated for each separate connection/reconnection). During the reconnection process, user prompts may be minimized by establishing a communication channel from the client process instance to a workspace runtime that manages the reconnections. Error conditions may be sent through this channel to the workspace runtime and collected there as received from multiple reconnection process instances in a single presentation to the user.

In using the present techniques, a user is able to reconnect to his or her remote resources in a workspace without needing to know which servers they run on, or which applications and desktops he or she was actively using. In addition, by serializing the first reconnection, and unifying the user interface, the user's experience in reconnecting is more seamless.

It can be appreciated by one of skill in the art that one or more various aspects of the invention may include but are not limited to circuitry and/or programming for effecting the herein-referenced aspects of the present invention; the circuitry and/or programming can be virtually any combination of hardware, software, and/or firmware configured to effect the herein-referenced aspects depending upon the design choices of the system designer.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

The systems, methods, and computer-readable media for reconnecting to a client's remote resources are further described with reference to the accompanying drawings in which:

FIG. 1 depicts an example general purpose computing environment in which in which techniques described herein may be embodied.

FIG. 2 depicts an example system where a client has a workspace that comprises remote sessions with a plurality of servers.

FIG. 3 depicts an example an example communication flow for a client reconnecting to a remote resource of a workspace.

FIG. 4 depicts example subcomponents of a client, request proxy and connection broker involved in a client reconnecting to a remote resource of a workspace.

FIG. 5 depicts example operational procedures for a connection broker that processes a request from a client to reconnect to a workspace that comprises connections with multiple remote servers of a server farm.

FIG. 6 depicts an example operational procedures flow for a client that reconnects a workspace to multiple remote servers of a server farm.

FIG. 7A depicts example user interface elements for the client in a reconnection process.

FIG. 7B depicts additional example user interface elements for the client in a reconnection process.

FIG. 7C depicts additional example user interface elements for the client in a reconnection process.

### DETAILED DESCRIPTION OF ILLUSTRATIVE EMBODIMENTS

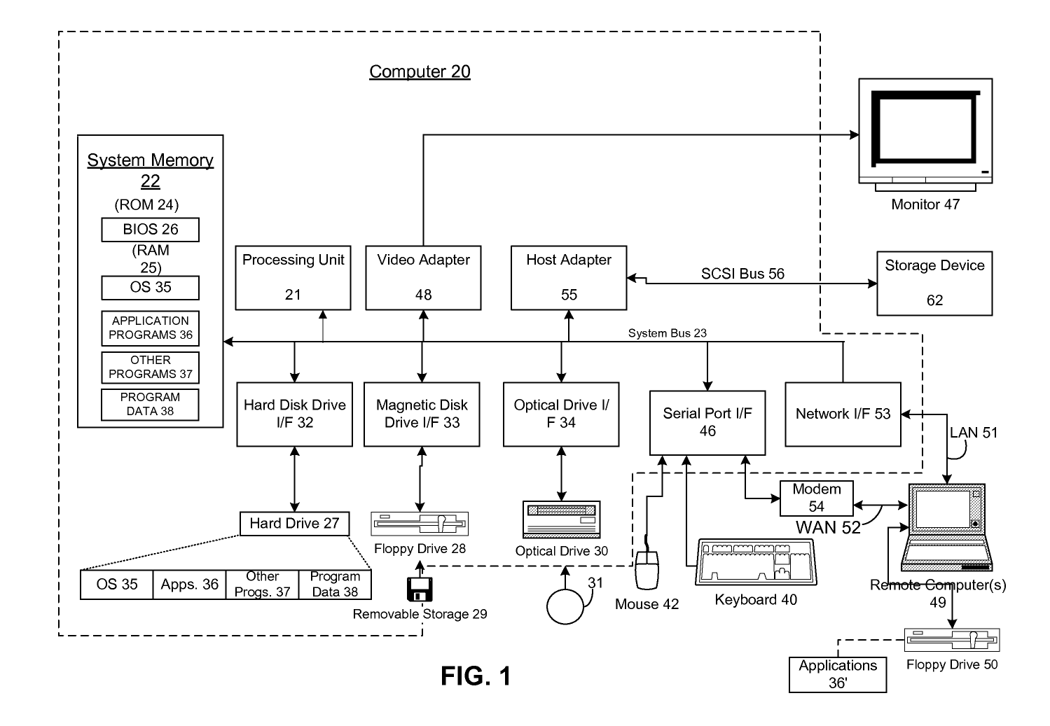

Embodiments may execute on one or more computer systems. FIG. 1 and the following discussion are intended to provide a brief general description of a suitable computing environment in which the disclosed subject matter may be implemented.

The term circuitry used throughout the description can include hardware components such as hardware interrupt controllers, hard drives, network adaptors, graphics processors, hardware based video/audio codecs, and the firmware used to operate such hardware. The term circuitry can also include microprocessors, application specific integrated circuits, and/or one or more processors, e.g., one or more cores of a multi-core general processing unit configured by instructions read from firmware and/or software. Processor(s) can be configured by instructions embodying logic operable to perform function(s) that are loaded from memory, e.g., RAM, ROM, firmware, and/or mass storage. In an example embodiment where circuitry includes a combination of hardware and software, an implementer may write source code embodying logic that is subsequently compiled into machine readable code that can be executed by a processor. Since one skilled in the art can appreciate that the state of the art has evolved to a point where there is little difference between hardware implemented functions or software implemented functions, the selection of hardware versus software to effectuate herein described functions is merely a design choice. Put another way, since one of skill in the art can appreciate that a software process can be transformed into an equivalent hardware structure, and a hardware structure can itself be transformed into an equivalent software process, the selection of a hardware implementation versus a software implementation is left to an implementer.

Referring now to FIG. 1, an exemplary general purpose computing system is depicted. The general purpose computing system can include a conventional computer 20 or the like, including at least one processor or processing unit 21, a system memory 22, and a system bus 23 that communicative couples various system components including the system memory to the processing unit 21 when the system is in an operational state. The system bus 23 may be any of several types of bus structures including a memory bus or memory controller, a peripheral bus, and a local bus using any of a variety of bus architectures. The system memory can include read only memory (ROM) 24 and random access memory (RAM) 25. A basic input/output system 26 (BIOS), containing the basic routines that help to transfer information between elements within the computer 20, such as during start up, is stored in ROM 24. The computer 20 may further include a hard disk drive 27 for reading from and writing to a hard disk (not shown), a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are shown as connected to the system bus 23 by a hard disk drive interface 32, a magnetic disk drive interface 33, and an optical drive interface 34, respectively. The drives and their associated computer readable media provide non volatile storage of computer readable instructions, data structures, program modules and other data for the computer 20. Although the exemplary environment described herein employs a hard disk, a removable magnetic disk 29 and a removable optical disk 31, it should be appreciated by those skilled in the art that other types of computer readable media which can store data that is accessible by a computer, such as flash memory cards, digital video disks, random access memories (RAMs), read only memories (ROMs) and the like may also be used in the exemplary operating environment. Generally, such computer readable storage media can be used in some embodiments to store processor executable instructions embodying aspects of the present disclosure.

A number of program modules comprising computer-readable instructions may be stored on computer-readable media such as the hard disk, magnetic disk 29, optical disk 31, ROM 24 or RAM 25, including an operating system 35, one or more application programs 36, other program modules 37 and program data 38. Upon execution by the processing unit, the computer-readable instructions cause the actions described in more detail below to be carried out or cause the various program modules to be instantiated. A user may enter commands and information into the computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port or universal serial bus (USB). A display 47 or other type of display device can also be connected to the system bus 23 via an interface, such as a video adapter 48. In addition to the display 47, computers typically include other peripheral output devices (not shown), such as speakers and printers. The exemplary system of FIG. 1 also includes a host adapter 55, Small Computer System Interface (SCSI) bus 56, and an external storage device 62 connected to the SCSI bus 56.

The computer 20 may operate in a networked environment using logical connections to one or more remote computers, such as a remote computer 49. The remote computer 49 may be another computer, a server, a router, a network PC, a peer device or other common network node, and typically can include many or all of the elements described above relative to the computer 20, although only a memory storage device 50 has been illustrated in FIG. 1. The logical connections depicted in FIG. 1 can include a local area network (LAN) 51 and a wide area network (WAN) 52. Such networking environments are commonplace in offices, enterprise wide computer networks, intranets and the Internet.

When used in a LAN networking environment, the computer 20 can be connected to the LAN 51 through a network interface or adapter 53. When used in a WAN networking environment, the computer 20 can typically include a modem 54 or other means for establishing communications over the wide area network 52, such as the Internet. The modem 54, which may be internal or external, can be connected to the system bus 23 via the serial port interface 46. In a networked environment, program modules depicted relative to the computer 20, or portions thereof, may be stored in the remote memory storage device. It will be appreciated that the network connections shown are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

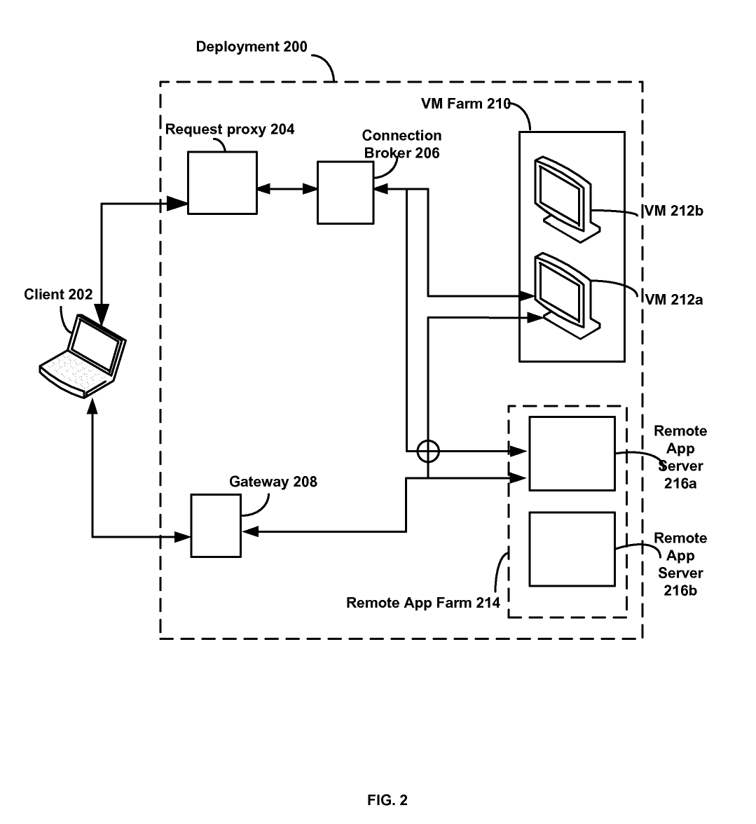

FIG. 2 depicts an example system where a client has a workspace that comprises remote sessions with a plurality of servers.

The computers depicted in FIG. 2 may be similar to the computer depicted in FIG. 1. In FIG. 2, a client 202 communicates with a deployment 200, which comprises request proxy 204, connection broker 208, gateway 208, remote application server farm 214 (which in turn comprises two homogenously configured servers, remote application servers 216a-b), and VM server farm 210 (which in turn comprises two homogenously configured VMs, VMs 212a-b).

Client 202 has a workspace that comprises multiple remote resources served by one or more of remote application servers 216 and VMs 212. Client 202 may log into its workspace through an request proxy 204. Once authenticated, the client's request to connect to its workspace is transmitted from request proxy 204 to connection broker 206. Connection broker 206 is configured to broker connections between client 202 and the application servers 216 and VMs 212 that will serve remote resources with client 202, and to effectuate this, connection broker 206 is configured to communicate with application servers 216 and VMs 212 to determine what resources they are currently serving (including disconnected sessions for a user of client 202).

Client 202 may have a workspace that comprises multiple remote resources—a remote resource comprising a remote application from remote application server 216a and a remote resource that comprises a VM from VM 212a. As depicted, client 202 does not have a remote resource with remote application server 216b or VM 212b. These may each serve different applications or desktops, versions of an application, or other permutations. For instance, remote application server 216a may be serving client 202 with a remoted word processor application, and VM 212 may be serving client 202 with a virtual desktop.

As can be seen through this depiction, when a user wishes to reconnect to his or her workspace, he may desire to reconnect to the remote resources of both remote application server 216a and VM 212a through one command, rather than through one command performed two times. The user may perform this reconnect operation from client 202, or from another client computer (such as where client 202 is the user's computer at work, and the user wishes to reconnect from a computer at home during the weekend).

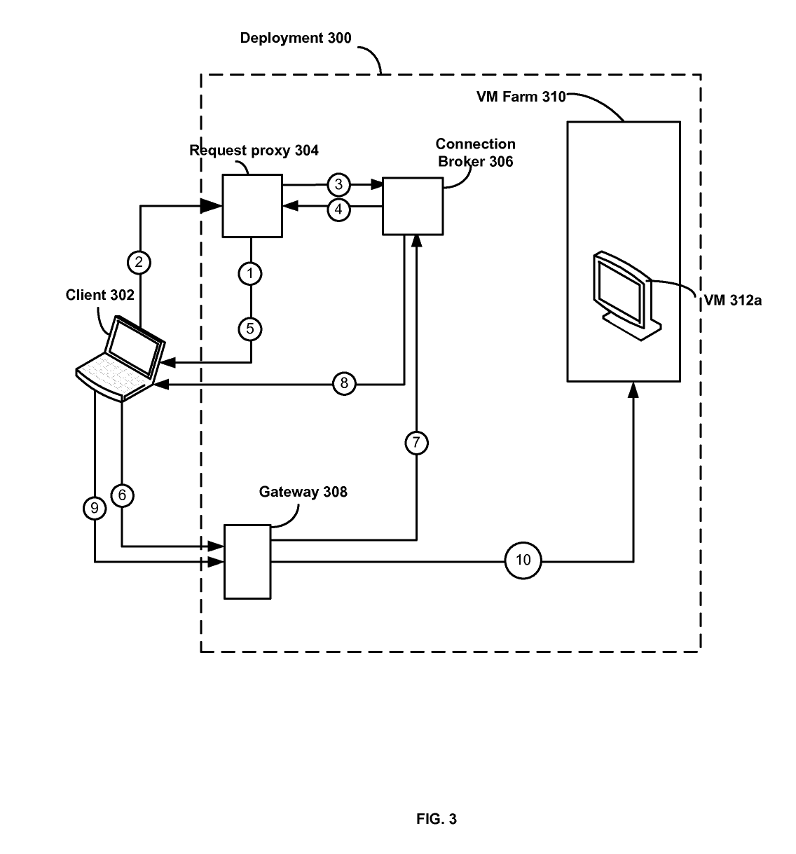

FIG. 3 depicts an example communication flow for a client reconnecting to a remote resource of a workspace.

FIG. 3 depicts an example communication flow in a system where a client reconnects a workspace that comprises remote sessions with a plurality of servers. This communication flow may be effectuated in a system, such as the computer system depicted in FIG. 2. To with, remote deployment 300, client 302, request proxy 304, connection broker 306, gateway 308, VM farm 310 and VM 312a of FIG. 3 may be similar to remote deployment 200, client 202, request proxy 204, connection broker 206, gateway 208, VM farm 210 and VM 212a, respectively, of FIG. 2.

A user of client 302 has previously had a workspace that involved accessing a remote resource from VM 312a and this workspace is now disconnected. In an alternative embodiment, user of client 302 could have been previously working on a different client that was connected to VM 312a and this workspace is still active when the user would like to reconnect. Before a user of client 302 attempts to reconnect to the deployment 300, request proxy 304 publishes a document (via communication (1)) to client 302 identifying information about the deployment 300 that client 302 may use to access the remote resources of the deployment 300. Client 302 later reconnects by sending communication (2) to request proxy 304. Request proxy 304 validates credentials of the user and/or client (such as a login and password). Where the credentials are validated, request proxy 304 communicates with connection broker 306 to determine which remote resources (here, VM 312a) client 302 is to reconnect to when reconnecting its workspace. Request proxy 304 makes this determination by sending communication (3) to connection broker 306, and, in response, receiving back in communication (4) a list of server farms (here, VM farm 310) for client 302 to reconnect to. This information indicated in communication (4) is passed by request proxy 304 to client 302 in communication (5).

When client 302 has the list of servers to reconnect to from request proxy 304, client 302 reestablishes a communication with each of those server farms. As depicted in FIG. 3, that server farm is VM farm 310. Client 302 communicates (6) with gateway 308 to access the remote resources of these server farms. Gateway 308 processes communication (6), and in turn communicates (7) with connection broker 306 to convey similar information. Connection broker 306 takes the identification of the server farm from communication (7) and from it, identifies the machine (VM 312a) within the farm 310 that has that a disconnected remote resource and/or an active remote resource for this user, but with a different client. Connection broker 306 sends communication (8) to client 302, instructing client 302 to reconnect to the remote resource on VM 312a. Client 302 reconnects with VM 312A by sending a communication (9) indicative of the same to gateway 308, which, in turn sends a communication (10) indicative of the same to VM 312a.

It may be appreciated that this is a simplified diagram to emphasize the present invention, and that more or fewer server farms may be present and/or reconnected to, and that the communications passed may be more involved (for instance, it is shown that communications (9) and (10) establish a reconnection between VM 312a and client 302, where this may also involve communications that are send from client 302 through gateway 308 and to VM 312a).

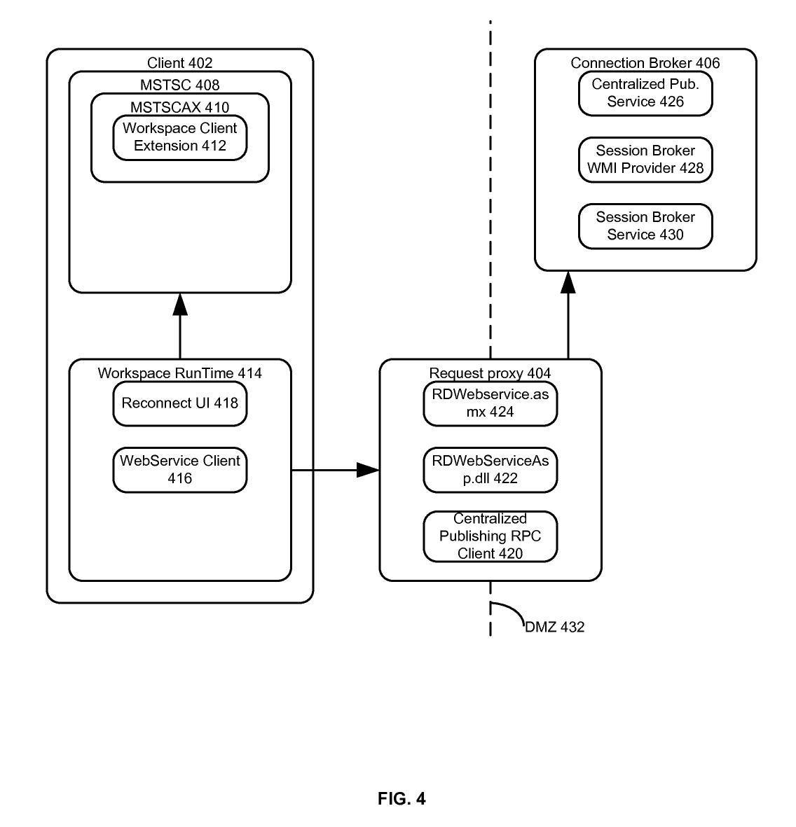

FIG. 4 depicts an example system architecture of a client, a request proxy, and a connection broker in which the present techniques may be used. The system architecture depicted in FIG. 4 is similar to a system architecture used in versions of the MICROSOFT WINDOWS operating system. Client 402, request proxy 404, and connection broker 406 may be similar to client 202, request proxy 204, and connection broker 206, respectively, of FIG. 2. Client comprises mstsc 408 and workspace runtime 414. In turn, mstsc 408 comprises mstcax 410 and workspace client extension 412, and workspace runtime 414 comprises reconnect user interface 418, and webservice client 416. Request proxy 404 comprises centralized publishing RPC client 420, RDWebServiceAsp.dll 422, and RDWebService.asmx 424. Connection broker 406 comprises centralized publication service 426, session broker WMI provider 428, and session broker service 430.

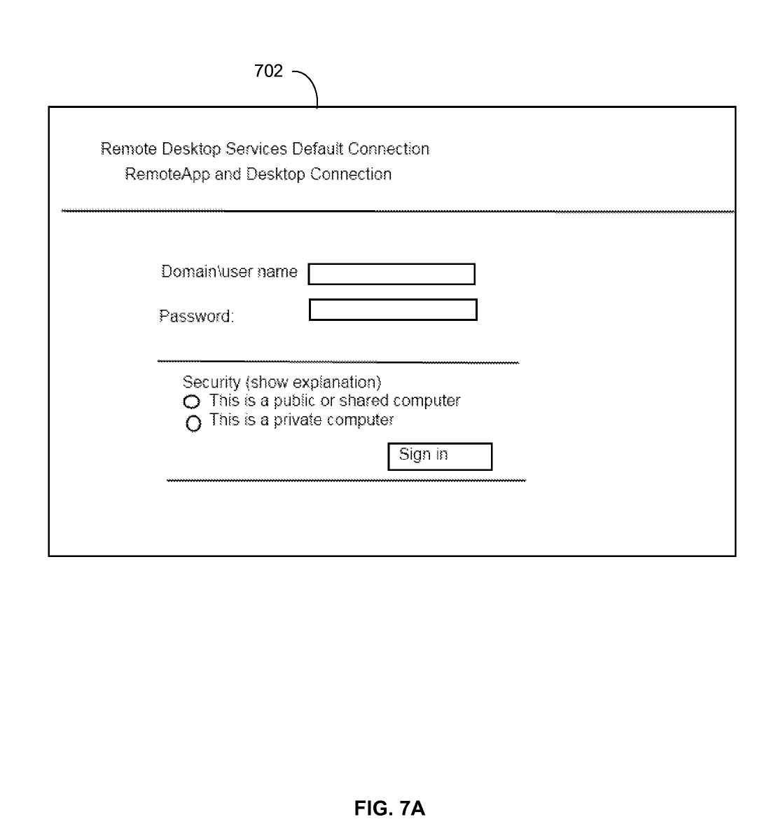

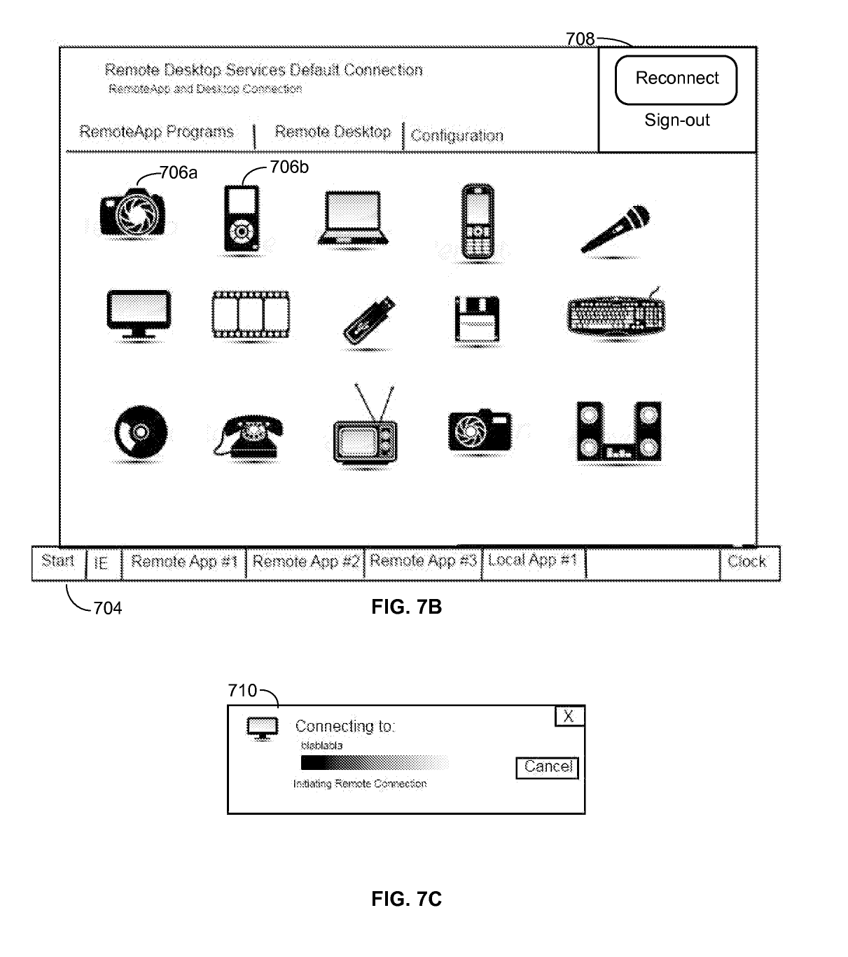

Workspace runtime 414 manages the workspace for client 402—it manages connecting to remote resources of the workspace, reconnecting to remote resources of the workspace, and causes instance of mstsc 408 to perform a connection or reconnection. Reconnect UI 418 presents a user interface to a user of client 402 to make input indicative of reconnecting. This user interface may be the user interface depicted by FIG. 7A. WebService Client 416 is a component of workspace runtime 414 that communicates with request proxy 404 for authentication of the user's credentials in reconnecting.

mstsc 408 is configured to connect or reconnect to a remote resource. One instance of mstsc 408 may perform one connection/reconnection, so workspace runtime 414 may instantiate multiple instances of mstsc 408 to connect/reconnect to multiple remote resources. mstsc 408 comprises mstscax 410—an ACTIVEX control for mstsc 408. In turn, mstscax 410 comprises workspace client extension 412. Where mstsc is a version of mstsc that has been implemented without consideration of the present techniques, the workspace client extension 412 may be added mstsc 408 to extend mstsc 408 so that workspace runtime 414 can communicate with mstsc 408 to cause the reconnection of the remote resources of a workspace.

DMZ (demilitarized zone) 432 comprises a physical or logical subnetwork that prevents client 402 from communicating directly to connection broker 406. Request proxy 404 straddles DMZ 432, such that it may communicate with client 402 over a communication network such as the INTERNET, and it may communicate with connection broker 406 on the intranet.

Request proxy 404 comprises RDWebServiceASP.dll 422 and RDWebservice.asmx 424—components that are configured to, in conjunction, serve web pages to client 402 that the client 402 may use to provide login credentials or other input. Request proxy 404 also comprises centralized publishing remote procedure call (RPC) client 420, which is configured to receive remote data files (that contain information on how the client can reconnect to a server farm that has the remote resource in question) from connection broker 406.

Connection broker 406 comprises centralized publishing service 426, which is configured to store remote data files and provide the same to centralized publishing RPC client 420. Connection broker 406 also comprises session broker service 430, which is configured to determine which machine among a plurality of machines in a server farm has a given remote resource associated with the user. Connection broker 406 also comprises session broker WMI (WINDOWS Management Instrumentation) provider 426, which is configured to provide an interface through which session broker service 430 provides information and notifications to other components.

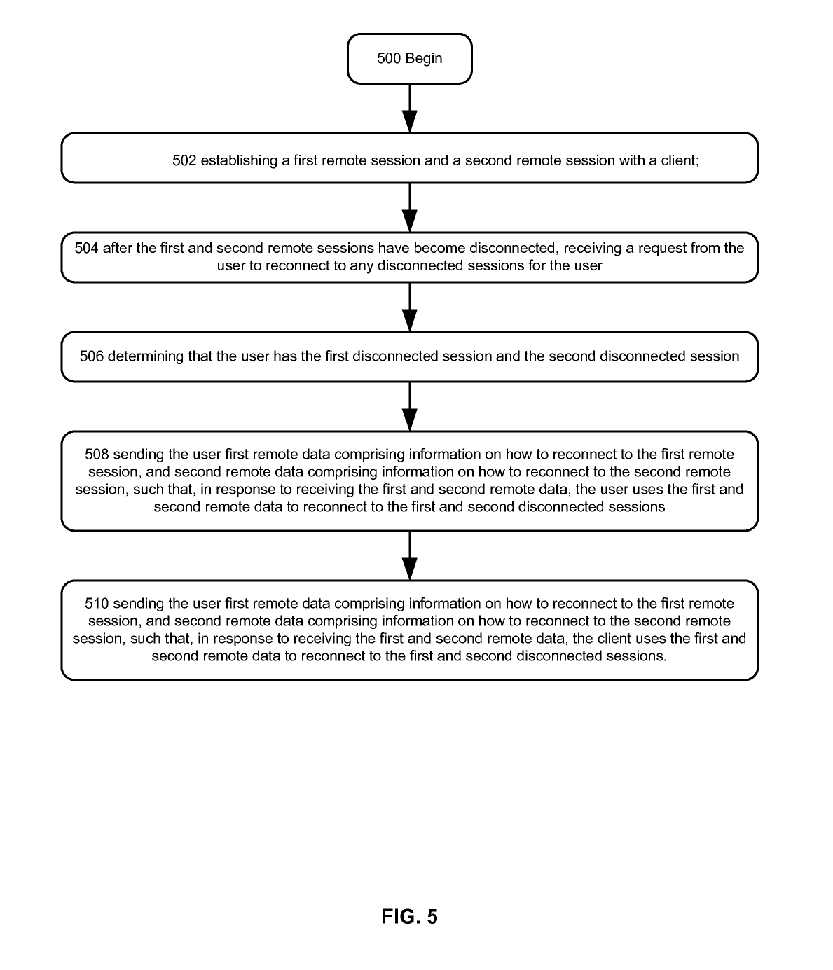

FIG. 5 depicts example operational procedures for a connection broker that processes a request from a client to reconnect to a workspace that comprises connections with multiple remote servers of a server farm. The operational procedures of FIG. 5 may be effectuated by the connection broker 206 of FIG. 2.

The operational procedures begin with operation 500. Operation 500 leads into operation 502, which depicts establishing a first remote resource and a second remote resource with a user. A user such as a user account associated with client 202 may be authenticated through request proxy 204 and then have a request to establish a remote resource with the connection broker. The connection broker may determine a server farm and a machine within that server farm that will serve that remote resource to the client. The client may then contact a gateway of the deployment which will route the client's communication to the machine determined by the connection broker, and that machine will then serve the remote resource to the client. In an embodiment, a remote resource that is established with a user at a client computer comprises a remote desktop, a remote application, or a pooled virtual machine (VM). The connection broker is configured not just to process reconnection requests for the client, but also to process connection requests for the client in the first place. When processing a connection request, a connection broker may receive a request from the client to connect to a new remote resource that the client is not disconnected from; determine a machine on a server farm to serve the remote resource to the client; and send an identifier of the determined machine to the client.

Operation 504 depicts, after the first and second remote resources have become disconnected, receiving a request from the user to reconnect disconnected resources for the user. After the user has established a first and second remote resource, the user may become disconnected from those resources (a disconnected resource being distinguished from a logged off resource or an active resource, as discussed previously). The user may then request that the connection broker reconnect to any disconnected resources that the connection broker can determine. The user does not necessarily specify the particular disconnected resources, as the user may possess information about which resources, if any, are reconnected. Rather, the user's request may indicate a desire to reconnect to disconnected resources that the connection broker is aware of, regardless of what those disconnected resources are, or, even, if there exist disconnected resources.

In an embodiment, receiving a request from the user to reconnect disconnected resources for the user comprises: receiving, by the connection broker, the request, the request having been directed to a request proxy that validated a credential of the user before sending the request to the connection broker. This may occur in a system architecture similar to as depicted in FIG. 2, where a client 202 contacts an authorization server 204, which validates a user's credentials before sending the request on to the connection broker 206.

Operation 506 depicts determining that the user has the first disconnected resource and the second disconnected resource. The request in 504 does not specify what the disconnected resources are, only that the client wishes to be reconnected to whatever its disconnected resources may be. Upon receiving that request, the connection broker determines the client's disconnected resources for the server farm, which in this case are the first disconnected resource and the second disconnected resource. The connection broker may do this, for instance, by maintaining a list of remote resources that it has established with the user, then querying each machine that serves/served one of those remote resources to determine the state of the remote resource (e.g. disconnected, active, or logged off).

Operation 508 depicts sending the user first remote data comprising information on how to reconnect to the first remote resource, and second remote data comprising information on how to reconnect to the second remote resource, such that, in response to receiving the first and second remote data, the user uses the first and second remote data to reconnect to the first and second disconnected resources. The connection broker may maintain information on how to connect to a remote resource, such as a machine name or identifier for the machine that serves the remote resource. The first remote data is data that contains information for reconnecting to the machine that serves the first remote resource, and the second remote data is data that contains information for reconnecting to the machine that serves the second remote resource.

In an embodiment, establishing a first remote resource with the user (as in operation 502) comprises: establishing a first remote resource with the user at a first computer; and sending the user the first remote data comprises: sending the user the first remote data at a second computer. The user may access these remote resources at different client computers, which may lead to the user lacking information on his or her remote resources when he attempts to reconnect—because he is attempting to reconnect from a different computer than where he originally connected from.

In an embodiment where the remote session comprises a first disconnected remote application and a second disconnected remote application, operation 508 includes: sending the user the first remote data such that, in response to receiving the first remote data, the user uses the first remote data to reconnect to the first disconnected remote application, and the second disconnected remote application. A user's disconnected remote resources may comprise not only disconnected sessions, but also disconnected remote applications. Where a connection broker, such as connection broker 206 of FIG. 2, receives a request for the user to reconnect to his or her disconnected resources, the connection broker may enumerate those disconnected sessions. One of those disconnected sessions for the user may not comprise a remote desktop for the user, but rather multiple remote applications. In such a scenario, where the connection broker 206 sends the user's client the remote data for that disconnected remote session, by reconnecting to the session, the user effectuates reconnecting to each of the disconnected remote applications within that session.

That is to say, where the user has multiple remote applications being served by one machine, those multiple remote applications may all execute within one session on that machine. So, where the user reconnects to one of those remote applications, he has reconnected to the session in which all the remote applications are executed. In such a scenario, the user does not need to receive information on how to reconnect to each of those remote applications (e.g. the user does not need to receive four separate remote data files for four remote applications), but only information on how to reconnect to one remote application.

Operation 510 depicts receiving, by the connection broker, a request from the user to reconnect to the first disconnected session, the request having been made with the first remote data, the request having been directed to a gateway, the request specifying a server farm; determining a machine of the server farm that has the first disconnected session; and sending an indication to the machine to reconnect the first disconnected session with the user.

Operation 510 may occur in a system architecture similar to the system architecture of FIG. 2. Client 202 contacts communication broker 206 (through request proxy 204) for information on how to reconnect to the remote resources. Once client 202 has this information, it contacts the gateway 208 of the deployment with an identification of a server farm that the client is to connect to (the client having received this identification, but not an identification of a particular machine within the server farm). The gateway 208 of the deployment then contacts the connection broker 206 with this information, and the connection broker 206 identifies that particular machine that has the disconnected session within the identified server farm.

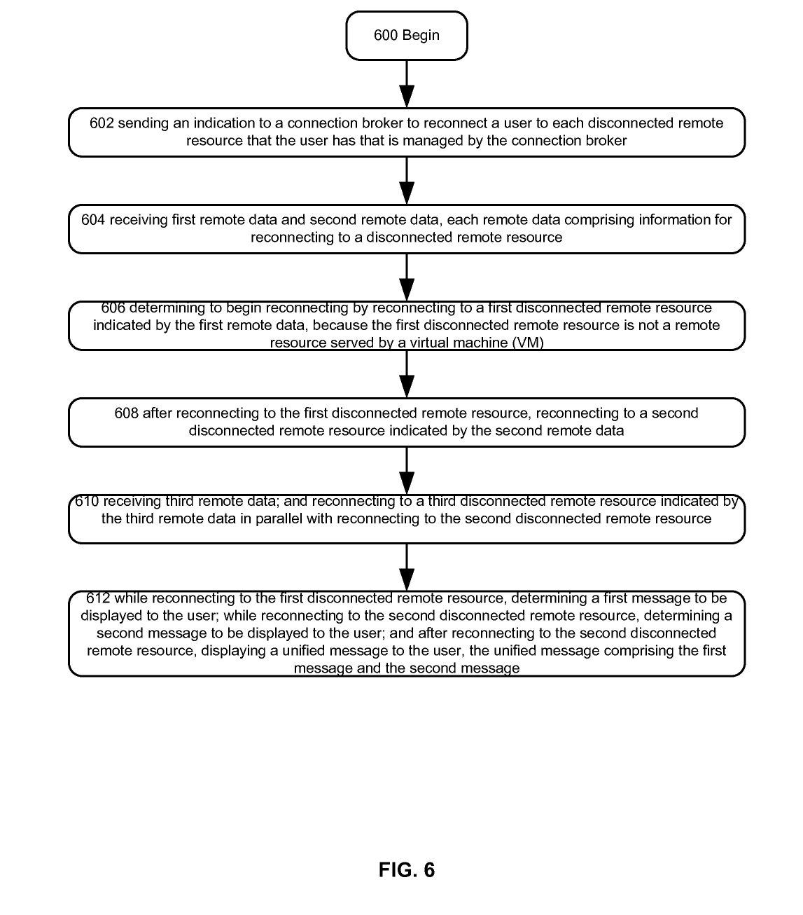

FIG. 6 depicts an example operational procedures flow for a client that reconnects a workspace to multiple remote servers of a server farm. These operational procedures may be implemented by client 202 of FIG. 2.

The operational procedures of FIG. 6 begin with operation 600. Operation 600 leads into operation 602, which depicts sending an indication to a connection broker to reconnect a user to each disconnected remote resource that the user has that is managed by the connection broker. The client's indication may not identify any particular remote resources, or even the number of remote resources that are to be reconnected to, but rather indicate that the client wishes to reconnect to any and/or all remote resources of the connection broker's deployment, whatever those remote resources may be.

In this manner, the user input that initiates the reconnection to the user's remote resources may not reference the first or second disconnected remote resources specifically, but only the reconnection of disconnected remote resources in general. In an embodiment, this user input comprises receiving a button push or a click on a link, the button or link not associated with any application remoted over a remote session. Insomuch as the user's reconnection indication may not identify any particular remote resources, the user's input may not either. For instance, if the user's disconnected remote resources comprise a word processor and a spreadsheet application, the user's input may not comprise clicking on either an icon for the word processor or an icon for the spreadsheet, but a more general button for reconnecting in and of itself, such as one that states “reconnect to disconnected resources.”

Operation 604 depicts receiving first remote data and second remote data, each remote data comprising information for reconnecting to a disconnected remote resource. This remote data may comprise, for instance, an identifier of a server farm on which the remote resource is served and an identifier of a gateway to that server farm.

In an embodiment, the first remote data indicates a server farm of the first disconnected remote resource, but not a machine within the server farm that served the first disconnected remote resource. The remote data may identify only the server farm of the remote resource but not the particular machine within the server farm. In this scenario, when the client sends a request to reconnect to the remote resource, this request is forwarded to the connection broker, which determines which machine within the server farm has the disconnected remote resource, and instructs that machine to reconnect the remote resource to the client.

Operation 606 depicts determining to begin reconnecting by reconnecting to a first disconnected remote resource indicated by the first remote data, because the first disconnected remote resource is not a remote resource served by a virtual machine (VM). The client may receive remote data for reconnecting to a plurality of remote resources—including remote desktops, remote applications, and VMs. Reconnecting to a VM may take a long time relative to reconnecting to a remote desktop or a remote application (it may take a few minutes), because the VM may be in a sleep state, a maintenance state, or otherwise unavailable to immediately reconnect the disconnected remote resource. The first remote resource is reconnected to before reconnecting to other remote resources (like the second remote resources as depicted in operation 608) because any need for user input is collected during the first reconnection, then stored and used in all other reconnections. In performing the reconnections with a first reconnection done serially, then all others done in parallel (reconnections are performed in parallel where some or all of the reconnections may be actively in progress at a single point in time) if the first reconnection is to a VM that is in a sleep state, it will slow down all reconnections.

Operation 608 depicts, after reconnecting to the first disconnected remote resource, reconnecting to a second disconnected remote resource indicated by the second remote data. In an embodiment, operation 608 includes, while reconnecting to the first disconnected remote resource, determining that user input is needed to reconnect; receiving the user input; and wherein reconnecting to the second disconnected remote resource comprises: reconnecting to the second disconnected remote resource with the user input. For instance, where the user's credentials are incorrect, expired, or otherwise need to be re-inputted by the user, they may be collected during the first reconnection, and then stored and re-used during subsequent reconnections, such as reconnecting to the second disconnected remote resource. In performing one reconnection before other reconnections, the user may be prompted only once, rather than multiple times, which may be the case where multiple reconnections are made in parallel to begin with.

In an embodiment, the first disconnected remote resource was initially established with a first client computer, and reconnecting to the first disconnected remote resource is performed by a second client computer. The user may move between computers between his initial connections and his reconnections—such as at his place of work and his place of residence. This is why a user may not have the information on his disconnected remote resources and must retrieve information about them from a connection broker before reconnecting to them.

In an embodiment wherein a remoting process is configured to connect to a remote resource by sending information comprising an execute protocol data unit (exec PDU), and reconnecting to the first disconnected remote resource comprises: indicating to an instance of the remoting process not to send the exec PDU. The client's reconnections may be managed by a workspace runtime, that manages instances of a reconnection process (like mstsc), as depicted in FIG. 4. A reconnection process may normally send an exec PDU to the deployment that indicates that the remote resource is to be instantiated on a server farm. In the present scenario, the client may not desire that a remote resource be newly instantiated, but rather that a pre-existing instance of a remote resource be reconnected to. Where this is the case, the workspace runtime may instruct the reconnection process to omit the exec PDU from the reconnection communication flow so that the client ends up reconnecting to a pre-existing instance of the remote resource from which the client is disconnected.

Operation 610 depicts receiving third remote data; and reconnecting to a third disconnected remote resource indicated by the third remote data in parallel with reconnecting to the second disconnected remote resource. As described above, where multiple remote resources are to be reconnected to, one remote resource is first reconnected to in series relative to the other reconnections (here, the first disconnected remote resource), and then the other remote resources are reconnected to in parallel (here, the second and third disconnected remote resources).

Operation 612 depicts, while reconnecting to the first disconnected remote resource, determining a first message to be displayed to the user; while reconnecting to the second disconnected remote resource, determining a second message to be displayed to the user; and after reconnecting to the second disconnected remote resource, displaying a unified message to the user, the unified message comprising the first message and the second message. In the same way that receiving user input is condensed into receiving it for the first reconnection so the user does not receive multiple prompts, messages to the user may be collected and displayed to the user at once. For instance, multiple reconnection attempts may cause messages to be displayed informing the user that a reconnection failed or was successful. These messages may be collected so that, rather than displaying multiple message windows that must be clicked through, they are displayed in one message window.

In an embodiment wherein the first disconnected resource is reconnected to by a first process, and the second disconnected resource is reconnected to by a second process, operation 612 includes: establishing a first communication pipe with the first process and a second communication pipe with the second process; receiving the first message from the first process via the first communication pipe; and receiving the second message from the second process via the second communication pipe. In a system architecture such as depicted in FIG. 4, a workspace runtime on the client may manage multiple reconnection processes (such as mstsc) that each reconnect to one session. In this system architecture, the messages from the processes may be collected by the workspace runtime, and the workspace runtime then displays them to the user in a unified manner. Each reconnection process may pass the message to the workspace runtime by establishing a communication pipe with the workspace runtime and transmitting the message to the workspace runtime using this communication pipe. The workspace runtime may store these received messages, and upon determining that all reconnection processes have been completed (successfully or no), display a unified message to the user.

FIG. 7A depicts example user interface elements for the client in a reconnection process. User interface 702 may comprise a initial login screen where a user enters his credentials to sign a client (such as client 202) into a request proxy (such as request proxy 204). Request proxy 204 may receive the user input of credentials received in this user interface and validate the user's credentials to validate the user for the deployment (such as deployment 200).

FIG. 7B depicts additional example user interface elements for the client in a reconnection process. After a user is successfully validated by a request proxy based on the credentials supplied in the user interface 702 of FIG. 7A, the request proxy may provide the user with information for user interface 704, which depicts remote resources that can be connected to 706, as well as the option to reconnect to any disconnected resources, whatever they may be via reconnect link 708.

FIG. 7C depicts additional example user interface elements for the client in a reconnection process. Where the user clicks reconnect link 708 in FIG. 7B, the request proxy may then provide the user with an interface 710 that displays to the user an indication that the workspace is being reconnected to. Upon the completion of the reconnection process, the user interface 710 may no longer be displayed, and the machines that serve those remote resources may send to the user interfaces for those remote resources that the user may interact with.

### CONCLUSION

While the present invention has been described in connection with the preferred aspects, as illustrated in the various figures, it is understood that other similar aspects may be used or modifications and additions may be made to the described aspects for performing the same function of the present invention without deviating there from. Therefore, the present invention should not be limited to any single aspect, but rather construed in breadth and scope in accordance with the appended claims. For example, the various procedures described herein may be implemented with hardware or software, or a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium. When the program code is loaded into and executed by a machine, such as a computer, the machine becomes an apparatus configured for practicing the disclosed embodiments. In addition to the specific implementations explicitly set forth herein, other aspects and implementations will be apparent to those skilled in the art from consideration of the specification disclosed herein. It is intended that the specification and illustrated implementations be considered as examples only.

What is claimed:

1. A method for reconnecting a client to a plurality of remote sessions, comprising:
establishing a first remote session and a second remote resource with a client;
after the first and second remote sessions have become disconnected, receiving a request from the user to reconnect disconnected sessions for the user;
determining that the user has the first disconnected session and the second disconnected session; and
sending the user first remote data comprising information on how to reconnect to the first remote session, and second remote data comprising information on how to reconnect to the second remote session, such that, in response to receiving the first and second remote data, the client uses the first and second remote data to reconnect to the first and second disconnected sessions.

2. The method of claim 1, wherein the remote session comprises a first disconnected remote application and a second disconnected remote application, and wherein sending the user the first remote data includes:
sending the user the first remote data such that, in response to receiving the first remote data, the user uses the first remote data to reconnect to the first disconnected remote application, and the second disconnected remote application.

3. The method of claim 1, wherein establishing a first remote resource with the user comprises:
establishing a first remote session with the user at a first computer; and
wherein sending the user the first remote data comprises:
sending the user the first remote data at a second computer.

4. The method of claim 1, wherein a remote session comprises a remote desktop, a remote application, or a pooled virtual machine (VM).

5. The method of claim 1, wherein the method is performed by a connection broker, further comprising:
receiving, by the connection broker, a request from the user to reconnect to the first disconnected session, the request having been made with the first remote data, the request having been directed to a gateway, the request specifying a server farm;
determining a machine of the server farm that has the first disconnected session; and
sending an indication to the machine to reconnect the first disconnected session with the user.

6. The method of claim 1, wherein the method is performed by a connection broker, and wherein receiving a request from the user to reconnect disconnected sessions for the user comprises:
receiving, by the connection broker, the request, the request having been directed to a request proxy that validated a credential of the user before sending the request to the connection broker.

7. The method of claim 1, further comprising:
receiving a request from the client to connect to a new remote resource that the client is not disconnected from;
determining a machine on a server farm to serve the remote resource to the client; and
sending an identifier of the determined machine to the client.

8. A computer-readable storage medium, bearing computer-readable instructions, that when executed on a computer, cause the computer to perform operations comprising:
sending an indication to a connection broker to reconnect a client to each disconnected remote session associated with the client;
receiving first remote data and second remote data, each remote data comprising information for reconnecting to a disconnected remote session;
sending a reconnection request for a first disconnected remote session indicated by the first remote data in response to determining that the first disconnected remote session is not a remote session served by a virtual machine (VM); and
after reconnecting to the first disconnected remote session, reconnecting to a second disconnected remote session indicated by the second remote data.

9. The computer-readable storage medium of claim 8, further bearing computer-readable instructions, that when executed on the computer, cause the computer to perform operations comprising:
receiving third remote data; and
reconnecting to a third disconnected remote session indicated by the third remote data in parallel with reconnecting to the second disconnected remote session.

10. The computer-readable storage medium of claim 8, further bearing computer-readable instructions, that when executed on the computer, cause the computer to perform operations comprising:
displaying a request for user input in response to determining that that user input is needed to reconnect;
receiving the user input; and
wherein reconnecting to the second disconnected remote session comprises:
reconnecting to the second disconnected remote session with the user input.

11. The computer-readable storage medium of claim 8, wherein the first disconnected remote session was initially established with a first client computer, and reconnecting to the first disconnected remote session is performed by a second client computer.

12. The computer-readable storage medium of claim 8, wherein sending an indication to a connection broker to reconnect a user to each disconnected remote session that the user has that is managed by the connection broker comprises:
receiving user input that does not reference the first or second disconnected remote sessions.

13. The computer-readable storage medium of claim 12, wherein receiving user input comprises receiving a button push or a click on a link, the button or link not associated with any application remoted over a remote session.

14. The computer-readable storage medium of claim 8, further bearing computer-readable instructions, that when executed on the computer, cause the computer to perform operations comprising:
while reconnecting to the first disconnected remote session, determining a first message to be displayed to the user;
while reconnecting to the second disconnected remote session, determining a second message to be displayed to the user; and
after reconnecting to the second disconnected remote session, displaying a unified message to the user, the unified message comprising the first message and the second message.

15. The computer-readable storage medium of claim 14, wherein the first disconnected session is reconnected to by a first process, and the second disconnected session is reconnected to by a second process, further comprising:
establishing a first communication pipe with the first process and a second communication pipe with the second process;
receiving the first message from the first process via the first communication pipe; and
receiving the second message from the second process via the second communication pipe.

16. The computer-readable storage medium of claim 8, wherein the first remote data indicates a server farm of the first disconnected remote session, but not a machine within the server farm that served the first disconnected remote session.

17. The computer-readable storage medium of claim 8, wherein a remoting process is configured to connect to a remote session by sending information comprising an execute protocol data unit (exec PDU), and wherein reconnecting to the first disconnected remote session comprises:
indicating to an instance of the remoting process not to send the exec PDU.

18. A system for connecting a client to a plurality of remote sessions in a deployment comprising:
a first server comprising:
a processor; and
a memory, wherein the memory include executable instructions that upon execution cause the processor to:
receive a request from the client to connect to any remote sessions of the deployment for a user, a remote session comprising a remote desktop, or a remote application;
authenticate a credential of the client in response to receiving the request;
send a first message to the connection broker indicative of the client requesting to connect to remote sessions for the user;
a second server comprising:
a second processor; and
a second memory, wherein the second memory includes executable instructions that upon execution cause the second processor to:
determine a first server farm corresponding to a first remote session;
send to the request proxy a second message indicative of data to be used to connect to the first sessions;
send, by the request proxy, to the client, a third message indicative of data to be used to connect to the first session;
receive, by the gateway, from the client a fourth message indicative of a request to connect the first session on the first server farm, the fourth message being based on the data to be used to connect the first session;
send, by the gateway, to the connection broker, a fifth message indicative of a request to connect the first session on the first server farm;
determine, by the connection broker, a first machine of the first server farm that serves the first session, in response to receiving the fifth message;
send, by the connection broker, a sixth message to the first machine, indicative of an instruction to connect the first session with the client; and
connect, by the first machine, the first session with the client, in response to receiving the sixth message.

19. The system of claim 18, the system being further configured to:
determine, by the connection broker, a second server farm corresponding to a second remote session of a second server farm and a third remote session of the second server farm, the second and third remote sessions each comprising a remote application that execute within a single session;
wherein the second message is further indicative of the second server farm;
receive, by the gateway, from the client, a seventh message indicative of a request to connect the second remote session on the second server farm, the seventh message being sent by the client after the client has connected the first session;
send, by the gateway, to the connection broker, a seventh message indicative of a request to connect the second session on the second server farm;
determine, by the connection broker, a second machine of the second server farm that serves the second session, in response to receiving the seventh message;
send, by the connection broker, a eighth message to the second machine, indicative of an instruction to connect the second session with the client; and
connect, by the second machine, the second session with the client, in response to receiving the eighth message.

20. The system of claim 18, the system being further configured to:
determine, by the connection broker, a second server farm corresponding to a second session in response to the connection broker receiving the first message;
wherein the second message is further indicative of data to be used to connect to the second session;
receive, by the gateway, from the client, a seventh message indicative of a request to connect the first session on the second server farm, the seventh message being sent by the client after the client has connected the first session;
send, by the gateway, to the connection broker, a seventh message indicative of a request to connect the second session on the second server farm;
determine, by the connection broker, a second machine of the second server farm that serves the second session, in response to receiving the seventh message;
send, by the connection broker, a eighth message to the second machine, indicative of an instruction to connect the second session with the client; and
connect, by the second machine, the second session with the client, in response to receiving the eighth message.
